(19) United States
(12) Patent Application Publication
(10) Pub. No.: US 2016/0093861 A1
(43) Pub. Date: Mar. 31, 2016

(54) BATTERY BUSBAR FOR CONNECTION AND DISCONNECTION

(71) Applicant: Apple Inc., Cupertino, CA (US)

(72) Inventor: David M. Rockford, Los Alamitos, CA (US)

(21) Appl. No.: 14/500,932

(22) Filed: Sep. 29, 2014

(51) Int. Cl. H01M 2/20; G06F 1/16; H01M 10/42

(52) U.S. Cl. CPC H01M 2/204; H01M 10/4257; G06F 1/1635; G06F 1/1658; H01M 2220/30; H01M 2010/4271

(57) ABSTRACT

A power supply system for a portable electronic device is disclosed. The power supply system includes a number of battery cells distributed between a number of structural support members of a housing of the portable electronic device. The battery cells of the power supply can be separated so that they can be individually installed between the structural support members of the housing. After installing the battery cells a battery busbar of the power supply system can be subsequently slid through openings defined by the structural support members so that the battery busbar can electrically couple together battery cells separated by structural support members. The battery busbar can also be electrically coupled to a battery management unit of the power supply system, which can also be separated from the battery cells by a structural support member.

### FIELD

The described embodiments relate to installing a battery with distributed battery cells into an electronic device housing. More particularly, a method for coupling the distributed battery cells to a battery busbar after the battery cells are installed within the electronic device housing is described.

### BACKGROUND

As electronic devices achieve progressively smaller form factors and include increasingly greater amounts of functionality, innovative techniques are needed to integrate the components and circuitry necessary to provide the greater functionality to an electronic device. One way to increase an amount of space available in a product is to reduce a thickness of walls of a housing for the electronic device; however, such reductions in wall thickness can benefit from reinforcing members that increase structural integrity of the thin-walled housing. Unfortunately, the reinforcing members can make insertion of large components into the electronic device more challenging. In some cases, one particularly large component than can be challenging to insert into tight spaces is a battery pack or battery cell stack. Because individual battery cells are generally packaged together by manufacturing entities, all of the battery cells that form a discrete battery pack or battery cell stack must be able to squeeze into whatever space is available within the electronic device. Creating enough space for such a large component to fit in one piece can reduce an amount of flexibility of design of the housing and consequently reduce structural integrity and/or space available within the housing.

### SUMMARY

This paper describes various embodiments that relate to methods and apparatus for installing a distributed battery into an electronic device housing.

An electronic device is disclosed. The electronic device includes at least the following elements: a housing that includes a number of sidewalls and a bottom wall that cooperate to form an interior volume; a structural rib that includes an upper portion and a lower portion, the lower portion being integrally formed with the bottom wall; a battery busbar extending through an opening in the lower portion of the structural rib; a number of battery cells disposed within the interior volume defined by the housing, the battery cells including a first battery cell, and a second battery cell separated from the first battery cell by the structural rib. The battery busbar electrically couples the first battery cell and the second battery cell to a battery management unit.

A power supply system suitable for use in a portable computing device is disclosed. The power supply system includes at least the following: a number of battery cells; power distribution circuitry configured to regulate an amount of power supplied to the portable computing device; and a battery busbar detachably coupled to at least two of the battery cells and the power distribution circuitry. The battery cells separate from the battery busbar and the power distribution circuitry during insertion of the power supply system into a housing of the portable computing device to accommodate intervening structures of the housing.

A method for distributing battery cells of a power supply unit between a number of structural support members of an electronic device housing is disclosed. The method includes at least the following steps: inserting a number of battery cells into the electronic device housing, at least two of the battery cells being separated by a first structural support member; sliding a battery busbar through an opening defined by the first structural support member until electrical contacts on the battery busbar are substantially aligned with corresponding electrical connectors of at least two of the battery cells; and electrically coupling the battery busbar to each of the at least two battery cells.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an exemplary electronic device suitable for use with the described embodiments;

FIG. 1B shows an interior view of a base of the exemplary electronic device;

FIG. 2 shows an interior perspective view of a portion of the base and how a number of internal components disposed within the base can be electrically interconnected;

FIG. 3 shows another embodiment in which positive and negative battery busbars are depicted;

FIGS. 4A-4C show a number of views of a zero or low insertion force connector or used to couple a battery cell tab to a battery busbar;

FIGS. 5A-5C show a number of views of a board-to-board connector utilized to electrically couple a battery cell tab to a battery busbar;

FIGS. 6A-6B show a number of views of an embodiment in which a connector includes a battery cell tab having a metal tip that gets soldered directly to a battery busbar;

FIGS. 6C-6D show a number of views of an embodiment in which a connector includes an interposer tab that connects a battery cell tab to a connector of a battery busbar; and

FIG. 7 shows a flow chart representing a method for attaching a number of battery cells to a battery busbar.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

One way to increase the structural soundness of a housing of a portable electronic devices is to add structural ribs or stiffening features to the housing. These types of structural support features can make the portable electronic device less susceptible to damage and in some cases can include integrated features for helping to mount various internal components within the housing. Unfortunately, the structural ribs and support features can make insertion of large components into the device substantially harder when an interval between the structural support features is too small. For example, a battery pack or battery cell stackup can have a particularly large area that doesn't allow it to fit between the interval between the structural support features when a number of battery cells are packaged together. In some embodiments, these prefabricated battery packs can be too large to fit between any of the structural support features distributed throughout the housing.

One solution to this problem is to separate the battery cells from interconnecting structures of the battery during assembly of the battery cells into the housing. In some embodiments, the battery cells can be detachably interconnected by an electrically conductive pathway. The electrically conductive pathway can take many forms including, for example a flexible wire, a cable, or a metal bar, sometimes referred to as a battery busbar. This paper will use the example of a rigid battery busbar when depicting the detachable interconnections; however, this is for exemplary purposes only and it should be understood that any interconnect system can be used to electrically couple together the battery cells. In some embodiments, the battery busbar can be a rigid metal bar, which prevents it from being routed or bent over and under obstructions. The large cross-section of the battery busbar, which makes it so rigid is advantageous because it minimizes electrical resistance between the discrete battery cells and a battery management unit (BMU). The BMU is operable to control power drawn from the battery cells and to supply power to electrical components of the portable electronic device to which it is coupled. Consequently, by separating the battery cells from the interconnecting structures and the BMU, the battery cells can each be maneuvered between the structural ribs or any other obstructing features positioned within the housing. After arranging each of the battery cells the battery busbar can be electrically coupled with the battery cells. In some embodiments, the battery busbars do not fit between the structural support members either. For this reason, small holes can be formed in the structural support members so that the battery busbars can be slid through the holes and into position next to each of the battery cells.

Once the battery busbars are prepositioned, interconnection of the battery cells to the battery busbars can be accomplished in any of a number of ways. In some embodiments, the battery busbars can engage spring interconnects on connectors welded to battery cell tabs of the battery cells. In some embodiments, the battery busbars can be locked against the spring interconnects by a locking mechanism. In some embodiments, the battery cell tabs of the battery cells can be welded directly to the battery busbars. In some embodiments, the battery cell tabs can include a board-to-board connector which mates with a board-to-board connector receptacle that is welded to the battery busbar. In some embodiments, the battery busbar can take the form of one or more flexible wires that route power through various openings or notches in the housing of the portable electronic device.

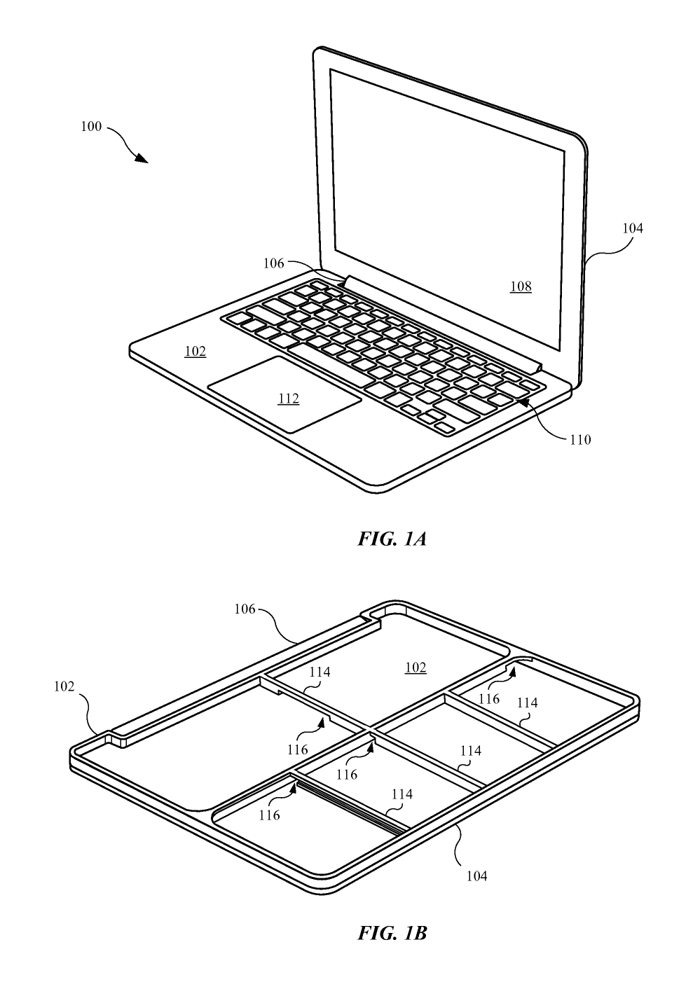

These and other embodiments are discussed below with reference to FIGS. 1A-7; however, those skilled in the art will readily appreciate that the detailed description given herein with respect to these figures is for explanatory purposes only and should not be construed as limiting.

FIG. 1A shows an exemplary electronic device 100 suitable for use with the described embodiments. In some embodiments, electronic device 100 can be a portable electronic device along the lines of a laptop computer. Electronic device 100 includes one housing component that takes the form of base 102 pivotally coupled to lid 104 by hinge assembly 106. Lid 104 can include a number of electrical components that include at least circuitry for supporting display assembly 108. In some embodiments, lid 104 can also include internal antennas for sending and receiving wireless signals. Base 102 can include a number of user interface components such as keyboard 110 and track pad 112 with which a user can interact with electronic device 100. FIG. 1B shows a perspective view of a bottom portion of electronic device 100. Base 102 can be configured to cooperate with a bottom cover (not depicted) to define an internal volume within which internal components can be positioned and protected.

FIG. 1B shows an interior view of base 102 after a bottom cover has been removed. Base 102 includes a number of integrally formed ribs 114 that extend entirely across or at least between ribs of base 102. Ribs 114 can be formed by a subtractive machining operation in which material around the ribs is removed, thereby leaving ribs 114 in position within a volume defined by various walls of base 102. Space between various ribs 12 can be insufficient to accommodate certain components. While subtractive machining operations allow for notches to be formed in ribs 114 to make accommodations for such components, placing breaks in ribs 114 can unduly compromise a structural integrity of base 102. Instead of creating notches that remove material from a top portion of ribs 114, undercuts can be machined through bottom portions of ribs 114. Openings 116 can allow various components or connections to be routed underneath various ribs 114. A position and size of openings 116 can be varied in accordance with a shape and size of the components that pass through a corresponding one of openings 116. In some embodiments, one or more components can be routed through multiple undercuts defined by multiple ribs 114. It should be noted that internal components have been excluded from FIG. 1B to better depict ribs 114 and openings 116.

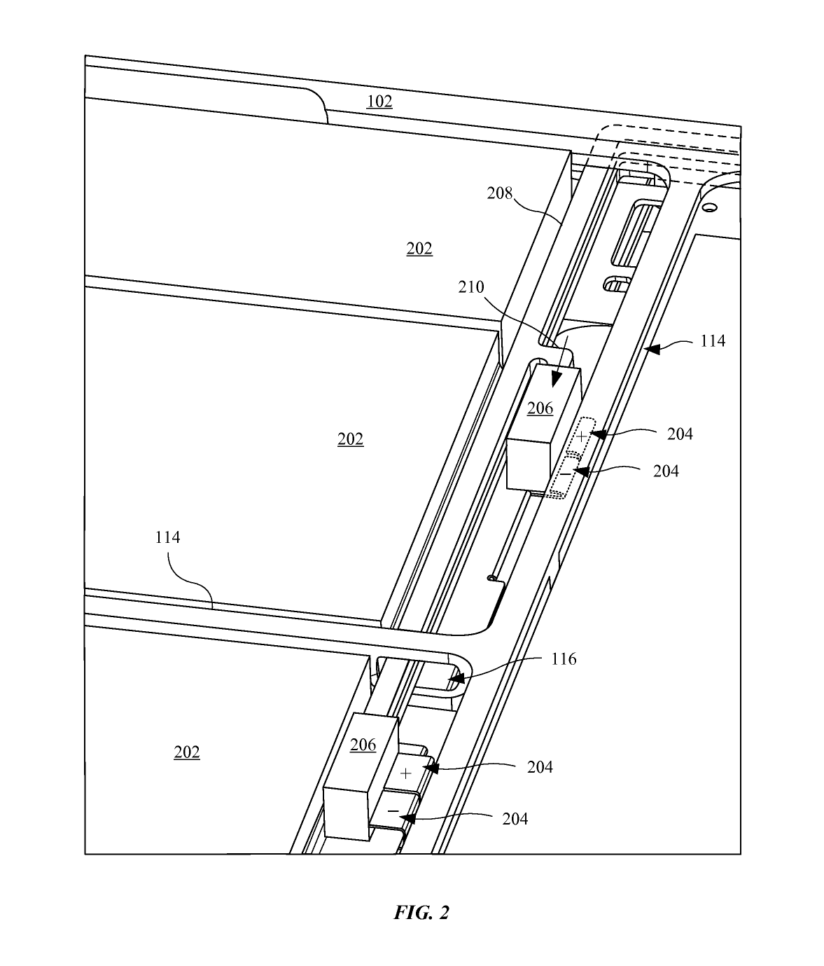

FIG. 2 shows a perspective view of a portion of base 102 and how a number of internal components disposed within base 102 can be electrically interconnected. In particular, battery cells 202 can be positioned within an interior volume formed at least in part by base 102. In some embodiments, battery cells 202 don't fit within base 102 unless they are separately installed between ribs 114. In some embodiments, battery cells 202 can be adhesively coupled to base 102. In other embodiments, battery cells 202 can be connected by way of an attachment feature. Battery cell tabs 204 of battery cells 202 can be coupled to connectors 206 in any number of ways. In some embodiments, battery cell tabs 204 can be welded to connectors 206. In some embodiments, connector 206 can include a zero or low insertion force connector for receiving tabbed ends of battery cell tabs 204. In some embodiments, one end of battery cell tab 204 can include a board-to-board connector for engaging a board-to-board receptacle of connector 206 that allows connector 206 to be electrically coupled with battery cell tab 204. Each of connectors 206 can be positioned in a substantially linear arrangement. In this way, connectors 206 can be engaged by battery busbar 208. Battery busbar 208 can be formed from electrically conductive material, along the lines of copper. Battery busbar 208 can have a large cross-sectional area that reduces an electrical resistance to power from each of battery cells that is routed from the battery cells to other power consuming components disposed within base 102 and/or lid 104. Battery busbar 208 can be configured to slide against contacts positioned on connectors 206. The contacts can take any number of forms, for example, the contacts can be embodied as spring contacts that provide positive feedback when engaging battery busbar 208. In some embodiments, a connection between connectors 206 and battery busbar 208 can be secured by locks that fit over both connector 206 and a portion of battery busbar 208 that engages connector 206. For example, a distal end of battery busbar 208 can engage one connection of one of connectors 206 and a lateral protrusion 210 of battery busbar 208 can engage the other one of connectors 206. In some embodiments, the securing locks include a pin alignment feature for aligning the locks with connectors 206. The sliding motion of battery busbar 208 is achieved by sliding battery busbar 208 through openings 116 in ribs 114. In some embodiments, connectors 206 can be fixed in place before positioning battery busbar 208 in proximity to a location at which connectors 206 are affixed, while in other embodiments, connectors 206 can all be positioned after sliding battery busbar 208 through openings 116.

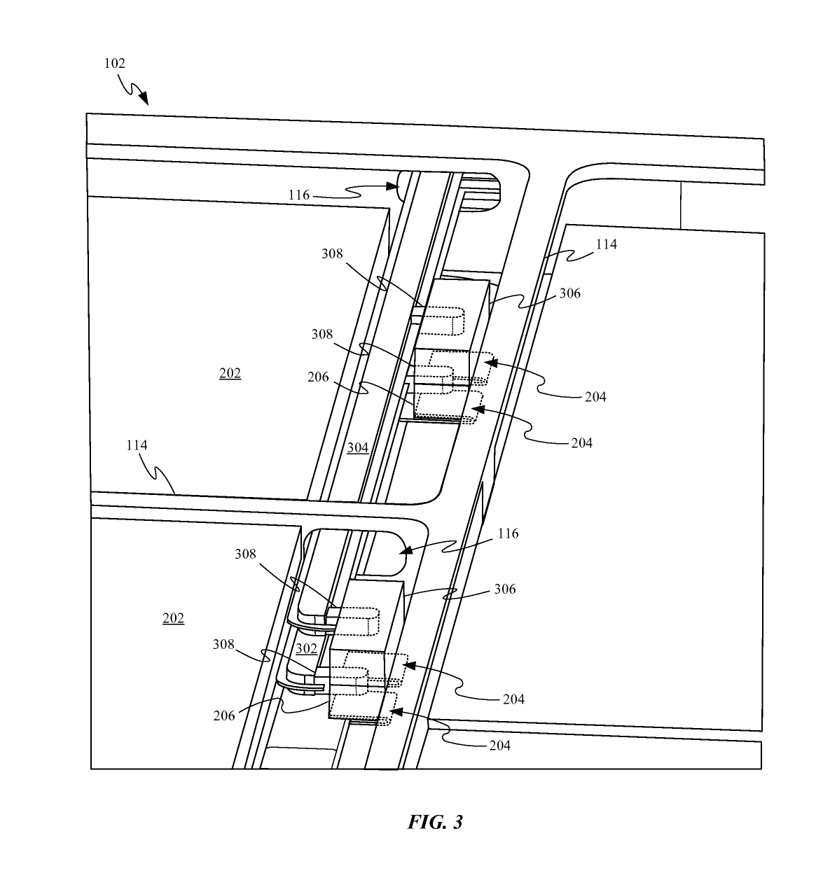

FIG. 3 shows another embodiment 300 in which positive battery busbar 302 and negative battery busbar 304 each contact connectors 206 in different locations. Battery cell tabs 204 of batteries 202 can be welded against a bottom surface of connectors 206. In this embodiment, positive battery busbar 302 and negative battery busbar 304 are each fixed to multiple connectors 206 by clamps 306. As in the aforementioned embodiment, the battery busbars can still be slid into position; however, in this embodiment, connection of terminals 308 of battery busbars 302 and 304 to connectors 206 is only secured once clamps 306 mate with each of connectors 206. In some embodiments, clamps 306 can be aligned with connectors 206 by an alignment pin (not shown). Connectors 206 can include discrete electrically conductive pathways for routing power between battery cell tabs 204 and terminals 308. In some embodiments, battery cell tabs 204 can be welded to a bottom surface of connectors 206. It should be noted that one benefit of securing the connection between connectors 206 and the busbars with clamps is that clamps are substantially better than for example fasteners at reducing an amount of torque and stress generated during thermal cycling of electronic device 100. Alternatively, in some embodiments, battery busbars 302 and 304 can take the form of electrically conductive cables or wires that electrically couple directly to battery cell tabs 204 and route electricity from the battery cells to a battery management unit (BMU) and/or power distribution circuitry. In some embodiments, each of battery cells 202 can include elongated battery cell tabs that can be utilized to route power from the battery cell at least part of the way to the BMU. In one specific embodiment battery cell tabs can be routed through at least one opening 116 prior to being coupled with a busbar or wire to facilitate transmission of the energy from the battery to power consuming components of electronic device 100.

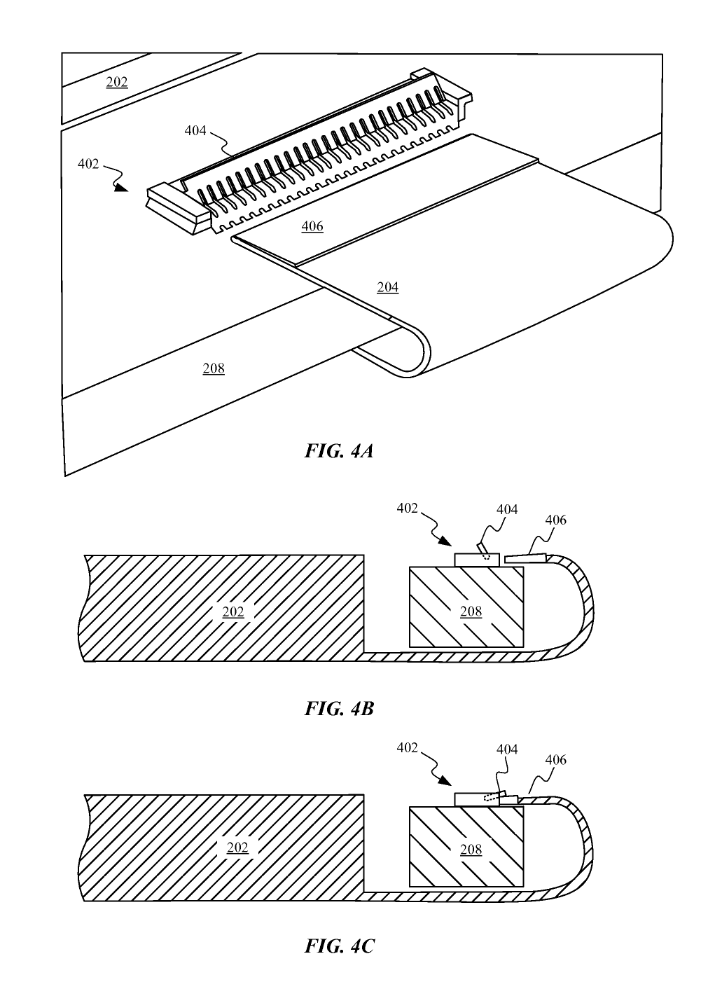

FIGS. 4A-4C show a number of views of a zero insertion force connector or a low insertion force connector 400 used to couple battery cell tabs 204 directly to battery busbar 208. FIG. 4A shows a perspective view of zero insertion force (ZIF) connector 402 affixed to a top-facing surface of battery busbar 208. ZIF connector 402 includes an arm 404 that is configured to rotate shut to trap and electrically couple with tabbed end 406 of battery cell tab 204. This embodiment has an advantage of not needing to add a connector element to battery cell tab 204. FIGS. 4B-4C show cross-sectional side views of ZIF connector in an uncoupled position (FIG. 4B) and an electrically coupled position (FIG. 4C). FIGS. 4B and 4C also depict how battery cell tab 204 can be routed beneath battery busbar 208. This routing can be simply accomplished by laying battery cell tab 204 out flat prior to installing battery busbar 208. In this way, after battery busbar 208 is installed battery cell tab 204 can be bent to engage ZIF connector 402.

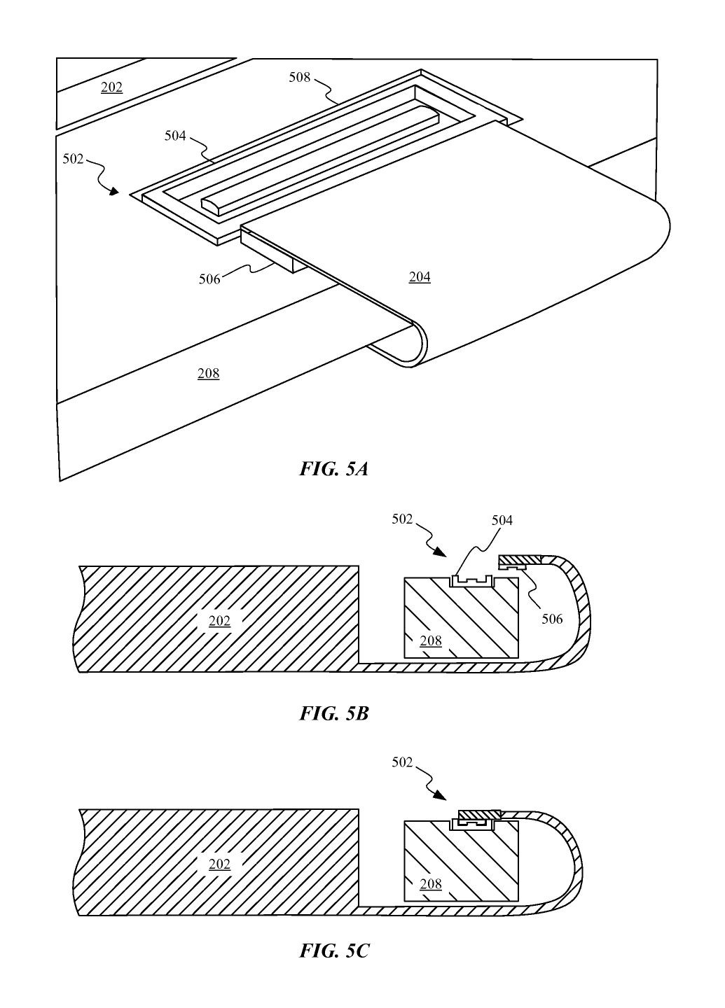

FIGS. 5A-5C show a number of views of a board-to-board connector 500. FIG. 4A shows a perspective view of board-to-board connector 502. Board-to-board connector 502 includes receptacle 504 of board-to-board connector 502 that is configured to receive connector 506 of board-to-board connector 502. Receptacle 504 can be positioned in a recess 508 of battery busbar 208. FIGS. 4B-4C show cross-sectional views of board-to-board connector 500 and consequently an amount that receptacle 504 is embedded within battery busbar 208. Connector 506 of board-to-board connector 502 can be fixed to a distal end of battery cell tab 204. Once connector 506 is engaged within receptacle 504, as depicted in FIG. 4C, a stack height of the connector can be minimized as a result of a substantial portion of board-to-board connector 502 being recessed within battery busbar 208. It should be noted that while only a single board-to-board connector is depicted, both positive and negative battery cell tabs 204 should have separate board-to-board connectors 502 for connecting both battery cell tabs 204 of each of batteries 202 to battery busbar 208.

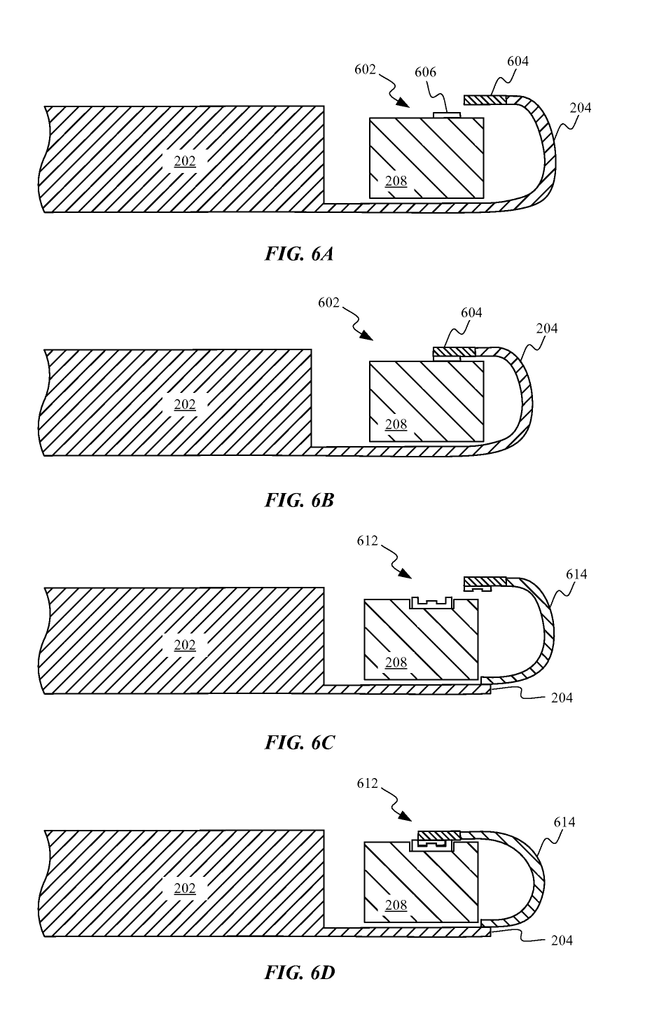

FIGS. 6A-6D show two additional connector embodiments. FIGS. 6A-6B shows an embodiment in which connector 602 includes battery cell tab 204 having metal tip 604 that gets soldered directly to battery busbar 208. In some embodiments, a metal tab can be welded to metal connector tab 606 which is welded to battery busbar 208. FIGS. 6C-6D show connector 612 which includes battery cell tab 204 coupled with battery busbar 208 by way of a secondary or interposer tab 614. Interposer tab 614 can be sized to accommodate a position and orientation of battery busbar 208. Slight misalignments in battery busbar 208 can be easily overcome by adjusting a size of orientation of interposer tab 614. While a board-to-board connector embodiment is used to illustrate this embodiment it should be understood that interposer tab 614 can be utilized with any of the embodiments discussed in this paper. Furthermore, in some embodiments, instead of utilizing interposer tab 614 to couple battery cell tab 204 to battery busbar 208, battery busbar 208 can be omitted entirely and an extended length interposer tab 614 can run all the way through the various routing openings to couple with circuitry along the lines of a BMU that is configured to distribute energy from battery cell 202 to components of an associated portable computing device.

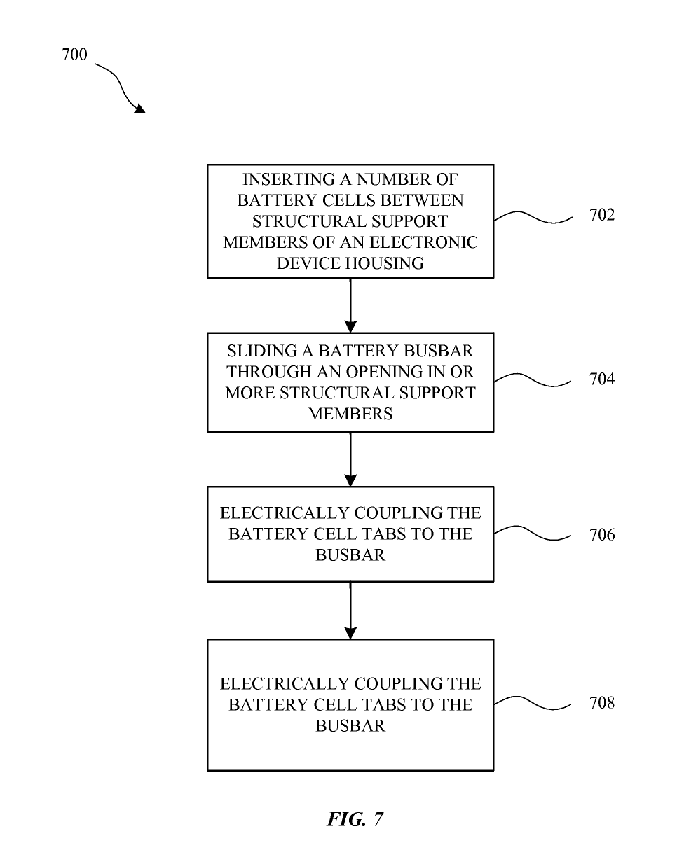

FIG. 7 shows a flow chart representing a method for attaching a number of battery cells to a battery busbar. At step 702, a number of battery cells are inserted between structural support members of an electronic device housing. At least one of the structural support members can include an opening configured to accommodate a battery busbar passing through the structural support member. At step 704, the battery busbar is slid through the opening or openings in the structural support members. At step 706, each of the battery cells is electrically coupled with the battery busbar by way of batter cell tabs which attach to connectors positioned upon the battery busbar. In some embodiments, the connectors on the battery busbar can be connected before assembly while in other embodiments the battery busbars can be connected to the connectors during assembly. At step 708, the battery busbar is electrically coupled to a battery management unit that is responsible for regulating an amount of power drawn from each of the battery cells when power is requested by electrical components of the electronic device housing.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An electronic device, comprising:
a housing, comprising a plurality of sidewalls and a bottom wall that cooperate to form an interior volume;
a structural rib, comprising an upper portion and a lower portion, the lower portion being integrally formed with the bottom wall;
a battery busbar extending through an opening in the lower portion of the structural rib;
a plurality of battery cells disposed within the interior volume defined by the housing, the plurality of battery cells comprising:
a first battery cell, and
a second battery cell separated from the first battery cell by the structural rib,
wherein the battery busbar electrically couples the first battery cell and the second battery cell to a battery management unit.

2. The electronic device as recited in claim 1, wherein the battery busbar comprises a positive battery busbar and a negative busbar.

3. The electronic device as recited in claim 1, wherein a surface defining the opening in the lower portion of the structural rib prevents the first and second battery cells from being removed from the housing without decoupling the first and second battery cells from the battery busbar.

4. The electronic device as recited in claim 1, wherein each of the battery cells is coupled to the battery busbar by way of an electrical connector.

5. The electronic device as recited in claim 4, wherein the electrical connector comprises a board to board connector.

6. The electronic device as recited in claim 4, wherein the battery busbar comprises a bar of electrically conductive metal, and wherein a receptacle portion of the electrical connector is recessed into a channel defined by the battery busbar.

7. The electronic device as recited in claim 4, wherein the electrical connector comprises a zero insertion force connector.

8. The electronic device as recited in claim 4, wherein each of the electrical connectors includes a locking mechanism that prevents inadvertent decoupling of the battery busbar from the electrical connector.

9. The electronic device as recited in claim 1, wherein the structural rib is a first structural rib and wherein the electronic device further comprises:
a second structural rib integrally formed with the bottom wall and separating the second battery cell from a third battery cell,
wherein the battery busbar extends through an opening in a lower portion of the second structural rib.

10. The electronic device as recited in claim 9, wherein a portion of the battery busbar disposed between the first structural rib and the second structural rib is substantially linear.

11. A power supply system suitable for use in a portable computing device, the power supply system comprising:
a plurality of battery cells;
power distribution circuitry configured to regulate an amount of power supplied to the portable computing device; and
a battery busbar detachably coupled to at least two of the battery cells and the power distribution circuitry,
wherein the plurality of battery cells separate from the battery busbar and the power distribution circuitry during insertion of the power supply system into a housing of the portable computing device to accommodate intervening structures of the housing.

12. The power supply system as recited in claim 11, wherein the battery busbar comprises:
a conductive metallic bar; and
a protrusion extending laterally from the conductive metallic bar that is configured to engage an electrical connector in electrical contact with a select one of the plurality of battery cells.

13. The power supply system as recited in claim 12, wherein a portion of the battery busbar that is electrically coupled to a select one of the battery cells is secured to an electrical connector of the battery cell by a locking mechanism.

14. The power supply system as recited in claim 13, wherein the electrical connector of the battery cell comprises a board-to-board connector.

15. The power supply system as recited in claim 14, wherein a portion of the board to board connector that is coupled to the battery busbar is positioned within a recess defined by the battery busbar.

16. A method for distributing battery cells of a power supply unit between a plurality of structural support members of an electronic device housing, the method comprising:
inserting a plurality of battery cells into the electronic device housing, at least two of the battery cells being separated by a first structural support member of the plurality of structural support members;
sliding a battery busbar through an opening defined by the first structural support member until electrical contacts on the battery busbar are substantially aligned with corresponding electrical connectors of at least two of the battery cells; and
electrically coupling the battery busbar to each of the at least two battery cells.

17. The method as recited in claim 16, further comprising electrically coupling the battery busbar to a battery management unit (BMU), the battery management unit configured to regulate an amount of electricity supplied to electrical components disposed within the electronic device housing.

18. The method as recited in claim 17, wherein sliding the battery busbar through the opening comprises sliding the battery busbar through an opening in the first structural support member and an opening in a second structural support member of the plurality of structural support members.

19. The method as recited in claim 18, wherein the second structural support member is positioned between the first battery cell and the BMU.

20. The method as recited in claim 16, wherein electrically coupling the battery busbar to each of the at least two battery cells comprises electrically coupling positive and negative battery cell tabs of the battery cells to an electrical connector of the battery busbar.
